(19) United States
(12) Patent Application Publication
(10) Pub. No.: US 2017/0186205 A1
(43) Pub. Date: Jun. 29, 2017

(54) INFORMATION PROCESSING SYSTEM, INFORMATION PROCESSING METHOD, AND PROGRAM

(71) Applicant: Tokyo Electric Power Company Holdings, Incorporated, Tokyo (JP)

(72) Inventors: Hitoshi FURUYA, Tokyo (JP); Kenjiro KASE, Tokyo (JP); Naohiro MINAMIDE, Tokyo (JP); Shuuji UENO, Tokyo (JP); Fumio ISHIGE, Tokyo (JP); Kouichi ONODERA, Tokyo (JP); Katumi YAMADA, Tokyo (JP); Masayuki ICHIDA, Tokyo (JP); Keijiro SHIBUI, Tokyo (JP); Hideo MIZUOCHI, Tokyo (JP)

(73) Assignee: Tokyo Electric Power Company Holdings, Incorporated, Tokyo (JP)

(21) Appl. No.: 15/459,276

(22) Filed: Mar. 15, 2017

Related U.S. Application Data
(63) Continuation-in-part of application No. PCT/JP2014/081763, filed on Dec. 1, 2014.

(51) Int. Cl. G06T 11/60; G09B 29/00

(52) U.S. Cl. CPC G06T 11/60; G09B 29/008; G09B 29/007

(57) ABSTRACT

An information processing system includes an information acquisitor, a screen information generator, and a display controller. The information acquisitor acquires, from history information including at least information indicating a moving route between electric facilities uncharted on a map and utilized in past, information indicating a moving route utilized at the time of moving from a first electric facility to a second electric facility based on information indicating the first electric facility out of a plurality of electric facilities and information indicating the second electric facility connected to the first electric facility by a connection line. The screen information generator generates display screen information to generate a display screen based on the information acquired by the information acquisitor and indicating the moving route. The display controller displays the display screen on a display of the information processing terminal based on the display screen information generated by the screen information generator.

### BACKGROUND

Technical Field

Embodiments of the present invention generally relate to an information processing system, an information processing method, and a program.

Related Art

In related art, research and development have been made on a device to assist inspection for an electric facility.

In this respect, there is a known inspection and power outage planning assistance system for a generation/transformation unit, adapted to create a work plan in order to perform inspection, maintenance, repair, and construction for a facility/apparatus of a generation/transformation unit provided in a generation/transformation station in which power has to be interrupted during such work. The system is adapted to: store information related to facilities/apparatuses of the generation/transformation unit; store work information related to inspection, maintenance, repair, and construction performed in past with respect to the facilities/apparatuses of the generation/transformation unit; receive input of a model and specification related to a facility/apparatus to be a target of inspection, maintenance, repair, and construction out of electric power facilities included in the generation/transformation unit; determine candidates of the facility/apparatus in which power can be interrupted for inspection work based on the received facility/apparatus, and the stored information of the facilities/apparatuses and information related to inspection and the like; and calculate and determine, from among the generated candidates of the facilities in which power can be interrupted, operating workers and the number thereof based on a calculated and determined work load. These are disclosed in Japanese Unexamined Patent Application, First Publication No. 2010-239731.

Meanwhile, when a worker moves from a first electric facility located closest to a present position to another second electric facility connected by a connection line such as an electric wire in order to perform inspection work, there may be a case where the inspection work cannot be efficiently performed by taking time and labor for searching a moving route in the case where an efficient moving route and a moving route not displayed on a map are not transferred to the worker.

### SUMMARY

An information processing system may include, but is not limited to, an information acquisitor, a screen information generator, and a display controller. The information acquisitor may be configured to acquire, from history information including at least information indicating a moving route between electric facilities uncharted on a map and utilized in past, information indicating a moving route that can be utilized at the time of moving from a first electric facility to a second electric facility based on information indicating the first electric facility out of a plurality of electric facilities and information indicating the second electric facility connected to the first electric facility by a connection line. The screen information generator may be configured to generate display screen information to generate a display screen based on the information acquired by the information acquisitor and indicating the moving route. The display controller may be configured to display the display screen on a display of the information processing terminal based on the display screen information generated by the screen information generator.

Further features and aspects of the present disclosure will become apparent from the following detailed description of exemplary embodiments with reference to the attached drawings.

### BRIEF DESCRIPTION OF THE DRAWINGS

FIG. 1 is a diagram illustrating an exemplary configuration of an information processing system.

FIG. 2 is a diagram illustrating an exemplary display screen displayed by s GUI of an application program that assists inspection work executed by a user.

FIG. 3 is a diagram illustrating an exemplary hardware configuration of an information processor.

FIG. 4 is a diagram illustrating an exemplary hardware configuration of an information processing terminal.

FIG. 5 is a diagram illustrating an exemplary functional configurations of the information processor and the information processing terminal included in the information processing system.

FIG. 6 is a flowchart illustrating an exemplary flow of processing executed by the information processing terminal from start of an application to display of a second display screen.

FIG. 7 is a flowchart illustrating an exemplary flow of processing executed by a controller of the information processor while the processing from Step S100 to Step S180 is executed by the information processing terminal.

FIG. 8 is a sequence diagram illustrating an exemplary flow of processing performed between the information processor, a history information DB, and the information processing terminal in the information processing system.

FIG. 9 is a diagram illustrating an exemplary situation in which the information processing system is effectively utilized.

### DETAILED DESCRIPTION OF THE EMBODIMENTS

In embodiments, an information processing system may include, but is not limited to, an information acquisitor, a screen information generator, and a display controller. The information acquisitor may be configured to acquire, from history information including at least information indicating a moving route between electric facilities uncharted on a map and utilized in past, information indicating a moving route that can be utilized at the time of moving from a first electric facility to a second electric facility based on information indicating the first electric facility out of a plurality of electric facilities and information indicating the second electric facility connected to the first electric facility by a connection line. The screen information generator may be configured to generate display screen information to generate a display screen based on the information acquired by the information acquisitor and indicating the moving route. The display controller may be configured to display the display screen on a display of the information processing terminal based on the display screen information generated by the screen information generator.

In some cases, the information processing system may further include, but is not limited to, a specifying unit configured to specify the first electric facility based on electric facility identification information to identify each of the plurality of electric facilities.

In some cases, the information acquisitor specifies, as the first electric facility, the electric facility closest to the information processing terminal based on electric facility positional information indicating respective positions of the plurality of electric facilities and terminal positional information indicating a position of the information processing terminal.

In some cases, the information acquisitor specifies the second electric facility from among the plurality of electric facilities based on received operation.

In some cases, the information acquisitor may further include, but is not limited to, a history information storage configured to store the history information, wherein the information acquisitor acquires the history information from the history information storage.

In other embodiments, an information processing method may include, but is not limited to, acquiring, from history information including at least information indicating a moving route between electric facilities uncharted on a map and utilized in past, information indicating a moving route that can be utilized at the time of moving from a first electric facility to a second electric facility based on information indicating the first electric facility out of a plurality of electric facilities and information indicating the second electric facility connected to the first electric facility by a connection line; generating display screen information to generate a display screen based on the acquired information indicating the moving route; and displaying the display screen on a display of the information processing terminal based on the generated display screen information.

In other embodiments, a non-transitory computer readable storage medium that store a program that, when executed by a computer, causes the computer to perform at least: acquire, from history information including at least information indicating a moving route between electric facilities uncharted on a map and utilized in past, information indicating a moving route that can be utilized at the time of moving from a first electric facility to a second electric facility based on information indicating the first electric facility out of a plurality of electric facilities and information indicating the second electric facility connected to the first electric facility by a connection line; generate display screen information to generate a display screen based on the acquired information indicating the moving route; and display the display screen on a display of the information processing terminal based on the generated display screen information.

The term “facility” used in embodiments refers to every tangible thing, which can in generally be designed, constructed, built, manufactured, installed, and maintained for performing any purpose, activities or functions in human society. In some cases, the facility may include, but is not limited to, a permanent, semi-permanent or temporary commercial or industrial property such as building, plant, or structure for performing any purpose, activities or functions in human society.

The term “event” used in embodiments refers to something that happens such as a social occasion or activity.

The term “equipment” used in embodiments refers to a set of one or more tangible articles or physical resources such as, but not limited to, some structural or tangible elements, apparatus, devices, or implements used in an operation or activity; fixed assets other than land and buildings.

The term “equipment/material” used in embodiments refers to at least one of equipment and material, for example, equipment alone, material alone or in combination.

### First Embodiment

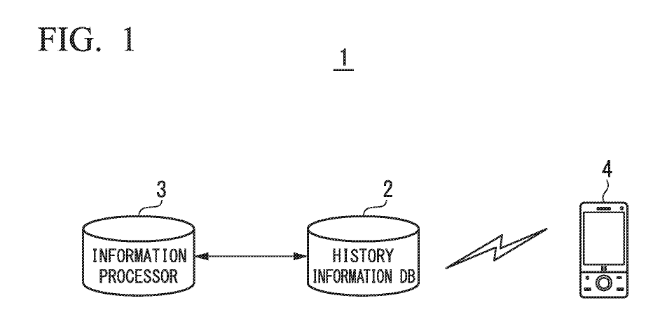

Hereinafter, Embodiment 1 of the present invention will be described with reference to the drawings. FIG. 1 is a diagram illustrating an exemplary configuration of an information processing system 1. The information processing system 1 includes an information processor 2, a history information database (DB) 3, and an information processing terminal 4.

First, an outline of the information processing system 1 according to Embodiment 1 will be described. The information processing system 1 assists inspection work to patrol and inspect an electric facility. Assisting the inspection work represents, for example, displaying, on the information processing terminal 4, moving route information indicating a moving route that can be utilized at the time of moving to another electric facility connected to a certain electric facility by a connection line when a user of the information processing system 1 patrols and inspects a plurality of electric facilities.

The electric facility may be an electric pole, a transformer, a switch, an electric wire, a cable, an on-road apparatus for an underground cable, or the like, but may also be another facility. In this example, a description will be provided in a case where the electric facility is an electric pole. The connection line is, for example, a power transmission line intended to transmit power between the electric poles, but the connection line may also be another connection line such as a communication cable.

The user of the information processing system 1 is, for example, an employee who inspects electric facilities owned by an electric company, but may also be a person who supports the employee, and the like. In the following description, the user of the information processing system 1 will be simply referred to as a user for convenience of explanation.

The information processor 2 is a server that generates display screen information in order to generate a display screen to assist the inspection work at the information processing terminal 4 based on various kinds of information transmitted from the information processing terminal 4. The information processor 2 transmits the generated display screen information to the information processing terminal 4.

The information processor 2 and the history information DB 3 are mutually connected in a communicable manner via wire or radio. Furthermore, the information processor 2 and the information processing terminal 4 are mutually connected in a communicable manner via wire or radio. Note that communication between the information processor 2 and the information processing terminal 4 is communication utilizing a mobile communication network, wireless local area network (LAN), or the like.

The history information DB 3 stores history information indicating a history of a moving route utilized in past in moving to another electric pole connected to a specific electric pole by a power transmission line. In the history information, for example, information to identify a combination of two electric poles connected by a power transmission line, electric pole positional information indicating respective positions of the two electric poles, and information indicating a moving route that links the two electric poles are stored in a correlated manner. The information indicating the moving route is, for example, a latitude and a longitude indicating a position per time series, but may also be other information. The electric pole positional information is an example of electric facility positional information.

The information processing terminal 4 is, for example, a tablet personal computer (PC), a multi-functional mobile phone (smartphone), a mobile phone terminal, an electronic book reader, a personal digital assistant (PDA), or the like. In the information processing terminal 4, an application program to assist the inspection work executed by the user is installed and assists the user's inspection work via a graphical user interface (GUI) of the application program. More specifically, the information processing terminal 4 displays a display screen to assist the inspection work via the GUI.

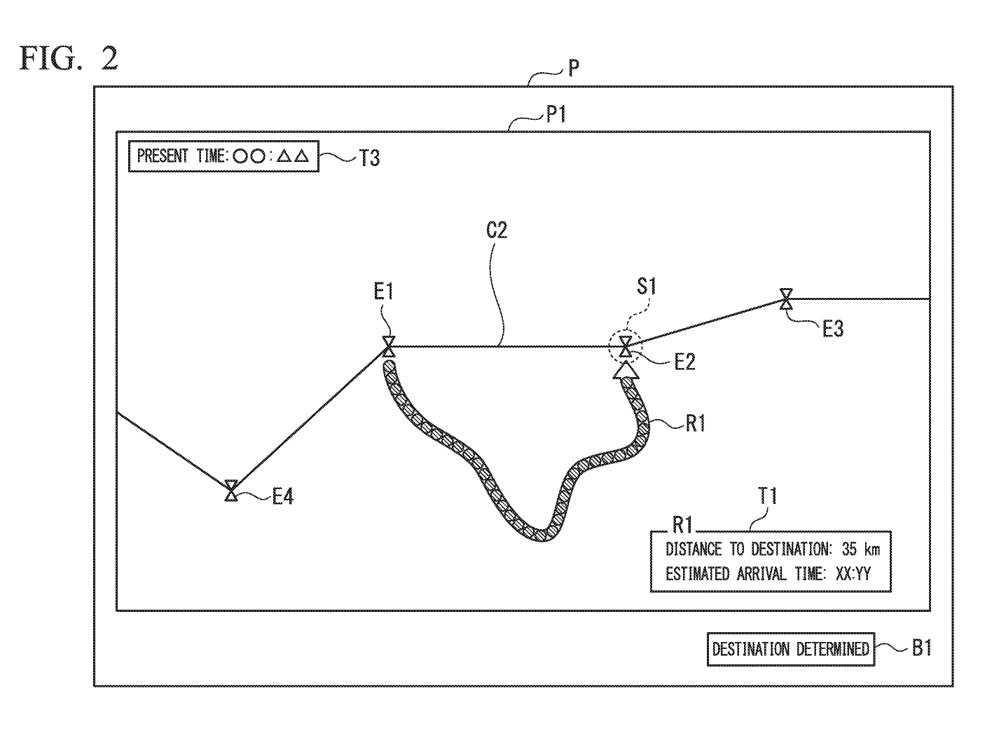

Here, the display screen displayed by the GUI of the application program that assists the inspection work executed by the user will be described with reference to FIG. 2. FIG. 2 is a diagram illustrating an exemplary display screen displayed by the GUI of the application program that assists the inspection work executed by the user.

As illustrated in FIG. 2, the GUI of the application program assisting the inspection work executed by the user is displayed on a display screen P by the information processing terminal 4. On the display screen P, at least a map P1 and a destination determined button B1 are displayed.

The map P1 is, for example, a diagram displayed by superimposing other information on a map that displays information indicating positions of a plurality of electric poles like a distribution line map, electric pole identification information to identify the plurality of electric poles, and information indicating a connecting relation between the electric poles by a power transmission line. On the map P1, at least displayed in a manner superimposed on a map of a certain region are: signs E1 to E4 indicating positions of the electric poles; a line segment indicating a power transmission line connected between the electric poles; information indicating an electric pole where the inspection work is currently executed by the user; information T3 indicating present time; information R1 indicating a moving route; and information T1 related to the moving route. In the following description, the electric poles at the positions respectively indicated by the signs E1 to E4 will be referred to as electric poles E1 to E4 for convenience of explanation. Furthermore, in the following description, the moving route indicated by the information R1 will be referred to as a moving route R1. Furthermore, in the following description, the electric pole currently under the inspection work will be referred to as a subject electric pole.

When the user starts the application program to assist the inspection work in the information processing terminal 4, the signs E1 to E4 indicating the positions of the electric poles, line segments indicating power transmission lines connected between these electric poles, the information indicating the electric pole currently under the inspection work by the user, and the information T3 indicating the present time are displayed in a manner superimposed on the map of a region including the present position of the information processing terminal 4 on the map P1 of the display screen P.

Subsequently, in the case where the destination determined button B1 is pushed after operation to select another electric pole different from the subject electric pole is performed by the user, the information R1 indicating a moving route and the information T1 related to the moving route are newly displayed on the map P1 in addition to the signs E1 to E4 indicating the positions of the electric poles, the line segments indicating the power transmission lines connected between the electric poles, the information indicating the electric pole currently under the inspection work by the user, and the information T3 indicating the present time, which are displayed in a manner superimposed on the map of the region including the present position of the information processing terminal 4. Furthermore, in the case where the destination determined button B1 is pushed, a sign S1 indicating a destination is displayed on the map P1 around a sign indicating a position of an electric pole selected as a destination. In the following, a description will be provided for a case where the subject electric pole is the electric pole E1 and the electric pole selected as the destination by the user is the electric pole E2. Furthermore, in the following description, the electric pole selected as the destination will be referred to as a target electric pole. In other words, the sign S1 is displayed around the target electric pole E2 on the map P1.

In the information T3 indicating the present time directly displays the present time in FIG. 2.

The information R1 indicating the moving route is the line segment formed along the moving route from the subject electric pole E1 to the target electric pole E2 in FIG. 2, but may also be other information instead of this. Note that the information R1 indicating the moving route is not necessarily to be information correlated to a road on the map displayed in a superimposed manner on the map P1. The information R1 indicating the moving route is the information also indicating a moving route uncharted on the map, such as an animal trail.

In FIG. 2, the information T1 related to the moving route includes the information indicating a distance to the destination (namely, target electric pole) and information indicating estimated arrival time, but may also include other information.

By displaying the above-described display screen P on the information processing terminal 4, the information processing system 1 provides the user with knowledge that can improve efficiency of inspection work passed from a worker who has patrolled/inspected the electric facility in past, and efficiency of patrol/inspection for the electric facility can be improved. As a result, the information processing system 1 enables a worker without special knowledge to efficiently execute the patrol/inspection work for the electric facility in the patrol/inspection work for the electric facility.

Note that information indicating the subject electric pole and information indicating the target electric pole may also displayed on the map P1. The information indicating the subject electric pole is, for example, a sign indicating the subject electric pole, but may also be other information. Furthermore, the information indicating the target electric pole is, for example, a sign indicating the target electric pole, but may also be other information. Furthermore, in the following description, the display screen before the destination determined button B1 is pushed will be referred to as a first display screen for convenience of explanation. Furthermore, in the following description, the display screen after the destination determined button B1 is pushed will be referred to as a second display screen.

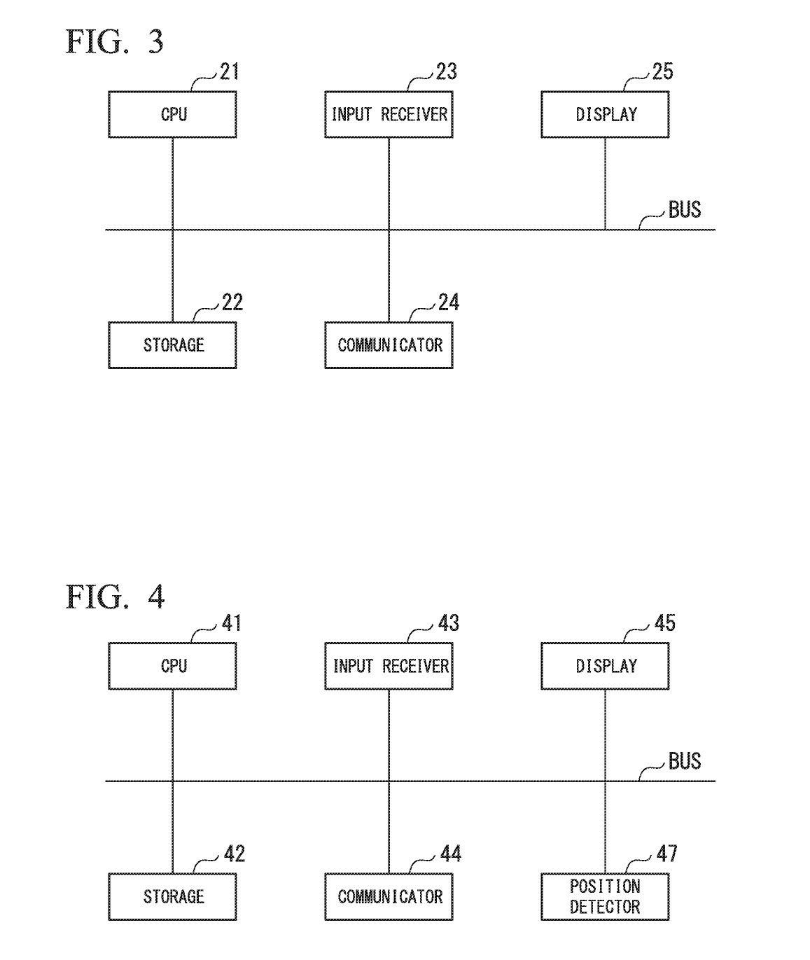

Next, a hardware configuration of the information processor 2 will be described with reference to FIG. 3. FIG. 3 is a diagram illustrating an exemplary hardware configuration of the information processor 2. The information processor 2 includes, for example, a central processing unit (CPU) 21, a storage 22, an input receiver 23, a communicator 24, a display 25, and communicates with other devices via the communicator 24. These components are mutually connected via a bus in a communicable manner. The CPU 21 executes various kinds of programs stored in the storage 22.

The storage 22 includes, for example, a hard disk drive (HDD), a solid state drive (SSD), an electrically erasable programmable read-only memory (EEPROM), a read-only memory (ROM), a random access memory (RAM), etc. and stores various kinds of information and images processed by the information processor 2, programs, and so on. Note that the storage 22 may be an external storage device connected by a digital input-output port such as a universal serial bus (USB) instead of being incorporated in the information processor 2.

The input receiver 23 includes, for example, a keyboard, a mouse, a touch pad, and other input devices. Note that the input receiver 23 may be formed as a touch panel integrated with the display 25.

The communicator 24 is formed by including, for example, a digital input-output port such as an USB, an Ethernet (registered trademark) port, and the like.

The display 25 is, for example, a liquid crystal display panel or an electro luminescence (EL) display panel.

Next, a hardware configuration of the information processing terminal 4 will be described with reference to FIG. 4. FIG. 4 is a diagram illustrating an exemplary hardware configuration of the information processing terminal 4. The information processing terminal 4 includes, for example, a CPU 41, a storage 42, an input receiver 43, a communicator 44, a display 45, and a position detector 47, and communicates with other devices via the communicator 44. These components are mutually connected via a bus in a communicable manner. The CPU 41 executes various kinds of programs stored in the storage 42.

The storage 42 includes a HDD, an SSD, an EEPROM, a ROM, a RAM, etc. and stores various kinds of information and images processed by the information processing terminal 4, programs, and so on. Note that the storage 42 may be an external storage device connected by a digital input-output port such as a USB instead of being incorporated in the information processing terminal 4.

The input receiver 43 includes, for example, a keyboard, a mouse, a touch pad, and other input devices. Note that the input receiver 43 may also be formed as a touch panel integrated with the display 45.

The communicator 44 is formed by including, for example, a digital input-output port such as an USB, an Ethernet (registered trademark) port, and the like.

The display 45 is, for example, a liquid crystal display panel or an organic EL display panel.

The position detector 47 is a global positioning system (GPS) sensor, for example, and acquires GPS information such as time information and satellite orbit data in order to calculate information of a latitude and a longitude where the information processing terminal 4 is located.

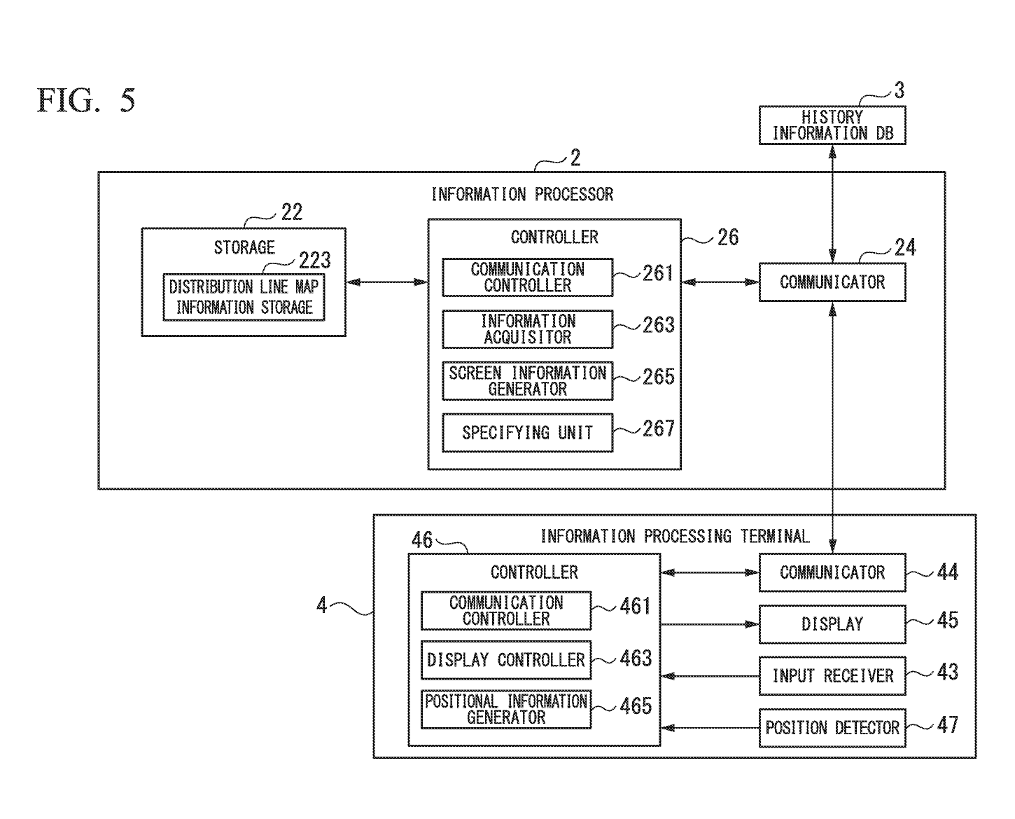

Next, functional configurations of the information processor 2 and the information processing terminal 4 included in the information processing system 1 will be described with reference to FIG. 5. FIG. 5 is a diagram illustrating an exemplary functional configurations of the information processor 2 and the information processing terminal 4 included in the information processing system 1.

The information processor 2 includes the storage 22, the communicator 24, and a controller 26. A part or all of functional components included in the controller 26 are implemented by, for example, the CPU 21 executing the various kinds of programs stored in the storage 22. Furthermore, a part or all of these functional components may be hardware functional components such as a large scale integration (LSI) and an application specific integrated circuit (ASIC).

The storage 22 includes a distribution line map information storage 223.

The distribution line map information storage 223 stores distribution line map information indicating a distribution line map. In the distribution line map information, at least the information indicating the plurality of electric poles and the information indicating the connecting relation between the electric poles by a power transmission line are included.

The controller 26 controls an entire portion of the information processor 2. The controller 26 receives terminal positional information indicating the position of the information processing terminal 4 from the information processing terminal 4 via the communicator 24. Furthermore, the controller 26 receives target electric pole information indicating the target electric pole via the communicator 24.

The controller 26 includes a communication controller 261, an information acquisitor 263, a screen information generator 265, and a specifying unit 267.

The communication controller 261 transmits the display screen information generated by the screen information generator 265 to the information processing terminal 4 via the communicator 24.

Furthermore, the information acquisitor 263 acquires, from the distribution line map information storage 223, distribution line map information indicating the distribution line map of a region including a position indicated by terminal positional information based on the terminal positional information received by the controller 26 from the information processing terminal 4. Furthermore, the information acquisitor 263 acquires, from the history information stored in the history information DB 3, moving route information indicating a moving route correlated to a combination of the subject electric pole and the target electric pole based on the electric pole identification information of the target electric pole received by the controller 26 from the information processing terminal 4 and the electric pole identification information of the subject electric pole specified by the specifying unit 267.

The screen information generator 265 generates display screen information based on the distribution line map and the electric pole identification information of the subject electric pole acquired by the information acquisitor 263. The display screen information is the display screen information to display the first display screen. In the following description, the display screen information will be referred to as first display screen information. Furthermore, the screen information generator 265 generates second display screen information based on: the first display screen information; the target electric pole information received by the controller 26 and indicating the target electric pole; and the moving route information acquired by the information acquisitor 263. In the target electric pole information, at least the target electric pole identification information is included. Note that, in the following description, the electric pole identification information of the subject electric pole will be referred to as subject electric pole identification information for convenience of explanation. Furthermore, in the following description, the electric pole identification information of the target electric pole will be referred to as target electric pole identification information.

The specifying unit 267 specifies (detects) the subject electric pole based on: the terminal positional information received by the controller 26 from the information processing terminal 4; and the information indicating the respective positions of the plurality of electric poles included in the distribution line map information acquired from the distribution line map information storage 223. Specifying the subject electric pole represents detecting the electric pole identification information correlated to the electric pole positional information of the subject electric pole.

The information processing terminal 4 includes the input receiver 43, communicator 44, the display 45, a controller 46, and the position detector 47. A part or all of functional components included in the controller 46 are implemented by, for example, the CPU 41 executing the various kinds of programs stored in the storage 42. Furthermore, a part or all of the functional components may be hardware functional components such as an LSI and an ASIC.

The controller 46 controls an entire portion of the information processing terminal 4. The controller 46 includes a communication controller 461, a display controller 463, and a positional information generator 465.

The communication controller 461 transmits the terminal positional information generated by the positional information generator 465 to the information processor 2 via the communicator 44. Furthermore, the communication controller 461 transmits the target electric pole information to the information processor 2 via the communicator 44 in response to operation to push the destination determined button received via the GUI.

The display controller 463 controls the display 45 to display the first display screen based on the first display screen information acquired from the information processor 2 via the communicator 44. The display controller 463 controls the display 45 to display the second display screen based on the second display screen information acquired from the information processor 2 via the communicator 44.

The positional information generator 465 acquires the GPS information from the position detector 47. Furthermore, the positional information generator 465 generates the terminal positional information indicating the position of the information processing terminal 4 based on the acquired GPS information.

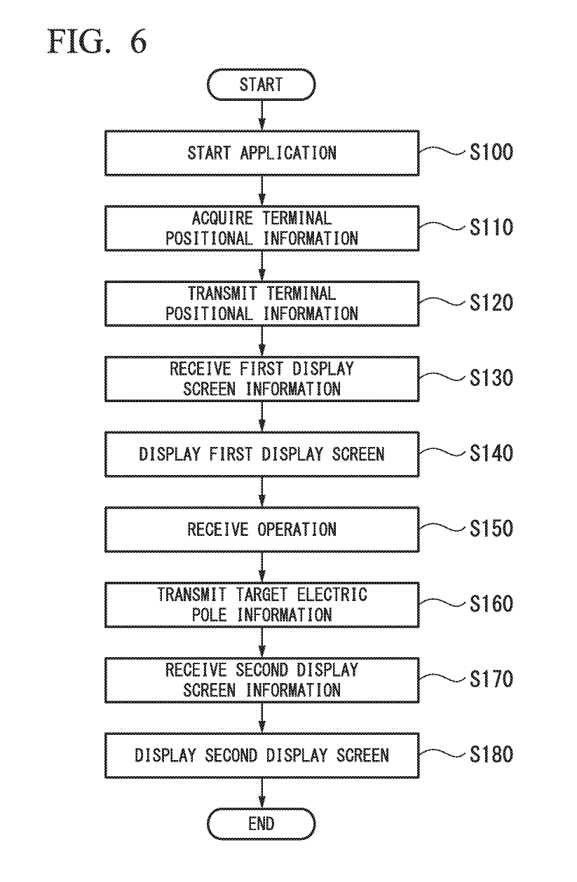

In the following, processing executed by the information processing terminal 4 from start of an application to display of the second display screen will be described with reference to FIG. 6. FIG. 6 is a flowchart illustrating an exemplary flow of the processing executed by the information processing terminal 4 from start of the application to display of the second display screen.

First, the controller 46 starts the application program assisting the inspection work executed by the user based on the operation received by the input receiver 43 from the user (Step S100). Note that the application program is referred to as the application in FIG. 6.

Next, the positional information generator 465 acquires the GPS information from the position detector 47. The positional information generator 465 generates the terminal positional information based on the acquired GPS information (Step S110). Next, the communication controller 461 transmits the terminal positional information generated by the positional information generator 465 in Step S110 to the information processor 2 via the communicator 44 (Step S120).

Next, the controller 46 receives the first display screen information from the information processor 2 via the communicator 44 (Step S130). Next, the display controller 463 controls the display 45 to display the first display screen based on: the information indicating the present time measured by a timer not illustrated; and the first display screen information received by the controller 46 in Step S130 (Step S140).

Next, the controller 46 receives the selecting operation to select the target electric pole from among the plurality of electric poles on the first display screen displayed on the display 45 via the GUI, and subsequently receives operation to push the destination determined button via the GUI (Step S150).

Next, the communication controller 461 transmits, to the information processor 2, the target electric pole information indicating the target electric pole selected in Step S150 via the communicator 44 (Step S160). Next, the controller 46 receives the second display screen information from the information processor 2 via the communicator 44 (Step S170). Next, the display controller 463 controls the display 45 to display the second display screen based on the second display screen information received by the controller 46 in Step S170 (Step S180).

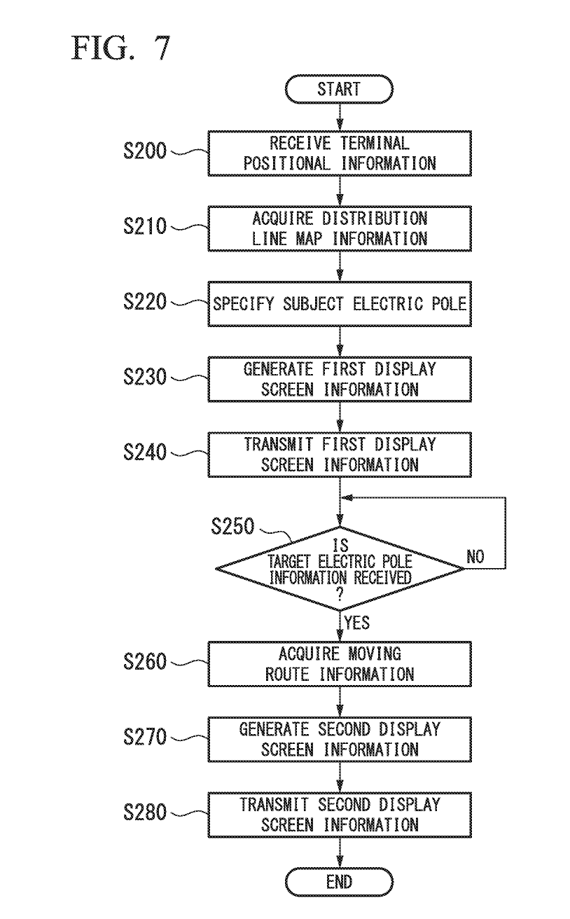

In the following, the processing executed by the controller 26 of the information processor 2 while the processing from Step S100 to Step S180 is executed by the information processing terminal 4 will be described with reference to FIG. 7. FIG. 7 is a flowchart illustrating an exemplary flow of the processing executed by the controller 26 of the information processor 2 while the processing from Step S100 to Step S180 is executed by the information processing terminal 4.

First, the controller 26 receives the terminal positional information from the information processing terminal 4 via the communicator 24 (Step S200). Next, the information acquisitor 263 acquires, from the distribution line map information storage 223, the distribution line map information of the region including the position indicated by the terminal positional information based on the terminal positional information received by the controller 26 in Step S200 (Step S210). Meanwhile, the information acquisitor 263 may also have a configuration of acquiring the distribution line map information of a whole country instead of the configuration of acquiring, from the distribution line map information storage 223, the distribution line map information of the region including the position indicated by the terminal positional information.

Next, the specifying unit 267 specifies the subject electric pole based on information shown below in A) to B) (Step S220).

A) Terminal positional information received by the controller 26 from the information processing terminal 4 in Step S200

B) Electric pole positional information indicating the respective positions of the plurality of electric poles included in the distribution line map information acquired from the distribution line map information storage 223 in Step S210

Here, processing of the specifying unit 267 to specify the subject electric pole will be described. The specifying unit 267 extracts an electric pole having the position indicated by the terminal positional information within a predetermined range based on the electric pole positional information indicating the respective positions of the plurality of electric poles included in the distribution line map information. The predetermined range is a range including a position of a specific electric pole and, for example, indicates a round-shaped range having a diameter of 10 meters or less centering the position of the certain electric pole. Note that the predetermined range may also have another shape and another size. The specifying unit 267 specifies (detects) the electric pole identification information correlated to the electric pole positional information of the extracted electric pole as the subject electric pole identification information.

Next, the screen information generator 265 generates the first display screen information based on the distribution line map information acquired by the information acquisitor 263 in Step S210 and the subject electric pole identification information specified by the specifying unit 267 in Step S220 (Step S230). Next, the communication controller 261 transmits the first display screen information generated by the screen information generator 265 in Step S230 to the information processing terminal 4 via the communicator 24 (Step S240).

Next, the controller 26 waits until the target electric pole information is received from the information processing terminal 4 via the communicator 24 (Step S250). In the case where the controller 46 receives the target electric pole information from the information processing terminal 4 via the communicator 24, the information acquisitor 263 acquires moving route information indicating the moving route correlated to the combination of the subject electric pole and the target electric pole from among the history information stored in the history information DB 3 based on the subject electric pole identification information specified by the specifying unit 267 in Step S220 and the target electric pole identification information included in the target electric pole information received by the controller 46 in Step S250 (Step S260).

Next, the screen information generator 265 generates the second display screen information based on: the first display screen information generated in Step S230; the moving route information acquired by the information acquisitor 263 in Step S260; and the information indicating the present time measured by the timer not illustrated (Step S270). Next, the communication controller 261 transmits the second display screen information generated by the screen information generator 265 in Step S270 to the information processing terminal 4 via the communicator 24 (Step S280).

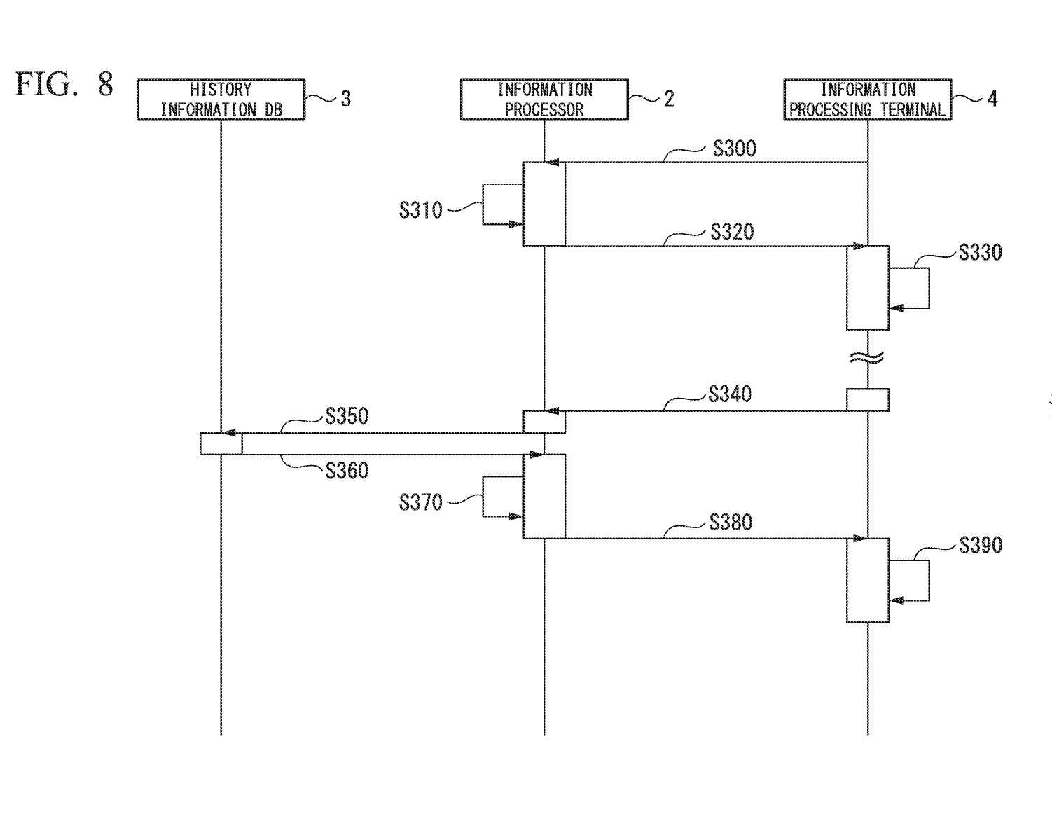

In the following, processing performed between the information processor 2, the history information DB 3, and the information processing terminal 4 in the information processing system 1 will be described with reference to FIG. 8. FIG. 8 is a sequence diagram illustrating an exemplary flow of the processing performed between the information processor 2, the history information DB 3, and the information processing terminal 4 in the information processing system 1. In the sequence diagram of FIG. 8, note that a description will be given for a case where the GUI is already displayed on the display 45 of the information processing terminal 4.

First, the information processing terminal 4 acquires the GPS information from the position detector 47, and generates the terminal positional information based on the acquired GPS information. Furthermore, the information processing terminal 4 transmits the generated terminal positional information to the information processor 2 (Step S300). The information processor 2 receives the terminal positional information from the information processing terminal 4. Then, the information processor 2 reads the distribution line map information indicating the distribution line map of the region including the position indicated by the terminal positional information based on the received terminal positional information. The information processor 2 specifies the subject electric pole based on the read distribution line map information and the received terminal positional information. The information processor 2 generates the first display screen information based on the read distribution line map information, the specified subject electric pole, and the information indicating the present time measured by the timer not illustrated (Step S310).

Next, the information processor 2 transmits the generated first display screen information to the information processing terminal 4 (Step S320). Next, the information processing terminal 4 receives the first display screen information from the information processor 2. Furthermore, the information processing terminal 4 displays the first display screen based on the received first display screen information (Step S330). In the following, a description will be given for a case where the information processing terminal 4 receives, by the input receiver 43, operation to select the target electric pole after the processing in Step S330, and then the destination determined button B1 is pushed by the user via the GUI displayed on the display 45 of the information processing terminal 4.

After the destination determined button B1 is pushed, the information processing terminal 4 transmits the target electric pole information to the information processor 2 (Step S340). Next, the information processor 2 receives the target electric pole information from the information processing terminal 4. Furthermore, the information processor 2 transmits, to the history information DB 3, a request for acquiring the moving route information indicating the moving route correlated to the combination of the subject electric pole specified in Step S310 and the target electric pole from among the history information stored in the history information DB 3 based on the target electric pole identification information included in the received target electric pole information (Step S350).

Next, the history information DB 3 receives, from the information processor 2, the request for acquiring the moving route information indicating the moving route correlated to the combination of the subject electric pole and the target electric pole. In response to the received request, the history information DB 3 transmits, to the information processor 2, the moving route information indicating the moving route correlated to the combination of the subject electric pole and the target electric pole (Step S360).

Next, the information processor 2 receives the moving route information from the history information DB 3 (Step S360). Next, the information processor 2 generates the second display screen information based on the received moving route information and the first display screen information (Step S370). Next, the information processor 2 transmits the generated second display screen information to the information processing terminal 4 (Step S380). Next, the information processing terminal 4 receives the second display screen information from the information processor 2. Furthermore, the information processing terminal 4 displays the second display screen based on the received second display screen information (Step S390).

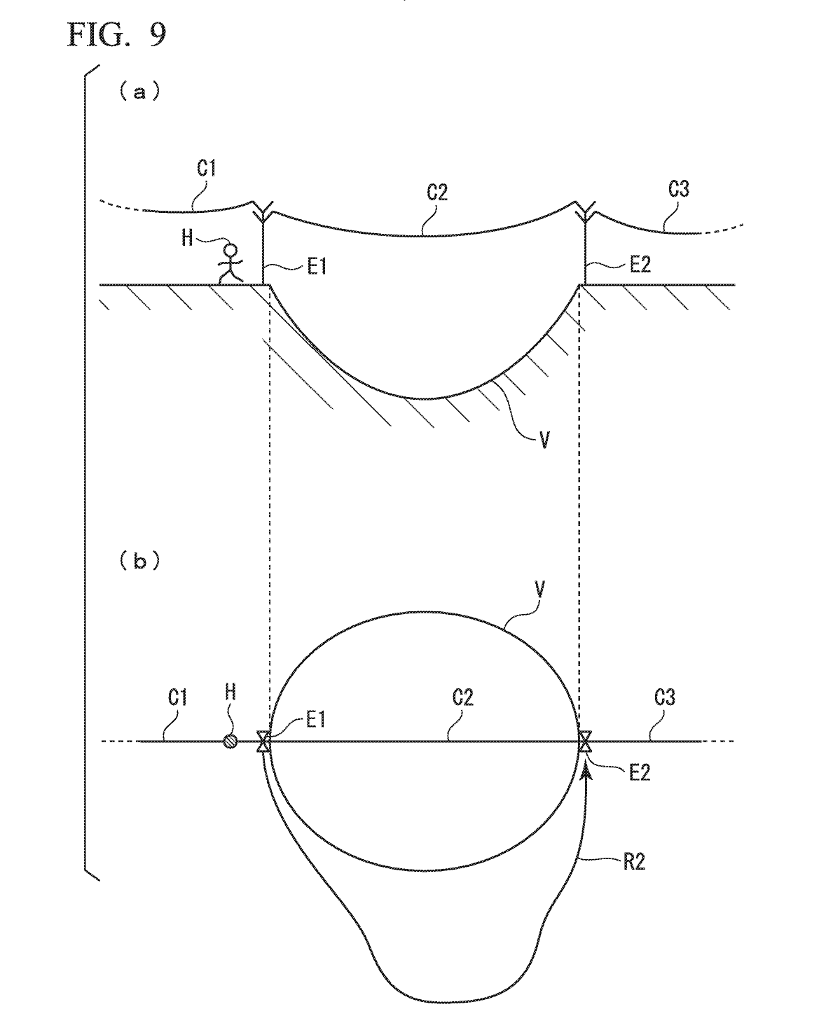

Next, an exemplary situation in which the information processing system 1 is effectively utilized will be described with reference to FIG. 9. FIG. 9 is a diagram illustrating the exemplary situation in which the information processing system 1 is effectively utilized. FIG. 9(a) illustrates an exemplary side view in a situation in which an inspection worker H is in the vicinity of a subject electric pole E1. Furthermore, FIG. 9(b) illustrates an exemplary top view in the situation in which the inspection worker H is in the vicinity of the subject electric pole E1.

The subject electric pole E1 is connected to an electric pole E2 by a power transmission line C2. Furthermore, the subject electric pole E1 is connected to another electric pole different from the electric pole E2 by a power transmission line C1. Additionally, the electric pole E2 is connected to another electric pole different from the subject electric pole E1 by a power transmission line C3. Furthermore, there is a valley V between the subject electric pole E1 and the electric pole E2. The valley V is a valley where the inspection worker H cannot pass through and there is no bridge provided. Furthermore, the inspection worker H can visually check the electric pole E2 from the vicinity of the subject electric pole E1. Furthermore, a direct distance between the subject electric pole E1 and the electric pole E2 is about three kilometers in FIG. 9. Here, a case where the electric pole E2 is a target electric pole will be described.

In the situation illustrated in FIG. 9, the inspection worker H needs to move from the subject electric pole E1 to the target electric pole E2 by making a detour around the valley V. For example, as illustrated in FIG. 9(b), the inspection worker H needs to move from the subject electric pole E1 to the target electric pole E2 along a detour route R2. At this point, when the detour route R2, namely, the moving route from the subject electric pole E1 to the target electric pole E2 is obvious, the inspection worker H can move along the detour route R2 without any problem. However, in the case where the detour route R2 is unclear and further the inspection worker needs to utilize the detour route R2 uncharted on the map, such as an animal trail, the inspection worker H may have to find the detour route R2 by repeating try and error.

To find such a detour route requires a lot of time, and therefore, efficiency of whole inspection work may be degraded. The information processing system 1 can transfer knowledge of the inspection workers in past by displaying, for the inspection worker, the information indicating the moving route as the second display screen based on the history information stored in the history information DB 3, namely, the history information to transfer knowledge of the inspection workers in the past. As a result, the information processing system 1 can improve efficiency of patrol/inspection for an electric facility (in this example, the electric pole). Note that the information processing system 1 may also have a configuration in which one or both of the information indicating the subject electric pole and the information indicating the target electric pole are specified by operation executed by the user.

As described above, the information processing system acquires, from the history information including the information indicating the moving route between electric facilities utilized in the past (for example, the history information in Embodiment 1), the information indicating the moving route that can be utilized at the time of moving from a first electric facility to a second electric facility based on: the information (for example, the subject electric pole identification information in Embodiment 1) indicating the first electric facility (for example, the subject electric pole in Embodiment 1) out of the plurality of electric facilities; and the information (for example, the target electric pole identification information in Embodiment 1) indicating the second electric facility (for example, the target electric pole in Embodiment 1) connected to the first electric facility by a connection line (for example, the power transmission line). Then, the information processing system 1 generates the display screen information (for example, the second display screen information in Embodiment 1) to generate the display screen (for example, the second display screen in Embodiment 1) based on the information indicating the acquired moving route, and displays the display screen on the display 45 of the information processing terminal 4 based on the generated display screen information.

Furthermore, the information processing system 1 specifies an electric facility located closest to the information processing terminal 4 as the first electric facility based on the electric facility positional information indicating the respective positions of the plurality of electric facilities and the terminal positional information indicating the position of the information processing terminal 4.

Furthermore, the information processing system 1 specifies the second electric facility from the plurality of electric facilities based on the received operation.

Moreover, the information processing system 1 includes a history information storage (for example, the history information DB 3 in Embodiment 1) to store the history information, and acquires the history information from the history information storage.

Note that the information processing system 1 may also have a configuration to specify the first electric facility based on the electric facility identification information to identify each of the plurality of electric facilities.

Consequently, the information processing system 1 can improve efficiency of patrol/inspection for the electric facility.

As described above, the embodiment of the present invention has been described in detail with reference to the drawings, but the concrete configuration is not limited to the embodiment, and modification, replacement, deletion, etc. may also be made without departing from the gist of the present invention.

Furthermore, a program to implement a function of an optional functional component in the above-described devices (for example, the information processor 2 and the information processing terminal 4 of the information processing system 1) may be recorded in a computer-readable recording medium, and the program may also be executed by causing a computer system to read the program. Note that the “computer system” here includes hardware such as an operating system (OS), and a peripheral device. Furthermore, the “computer-readable recording medium” represents portable media such as a flexible disk, a magneto optical disk, a ROM, and a compact disk (CD)-ROM, and a storage device such as a hard disk included in the computer system. Moreover, the “computer-readable recording medium” includes a recording medium that holds a program for a predetermined period like a volatile memory (RAM) inside a computer system to be a server or a client in the case where a program is transmitted via a communication line such as a network like the Internet or a telephone line.

Additionally, the above-described program may also be transmitted to other computer systems via a transmission medium or transmitted waves in the transmission medium from the computer system that stores the program in a storage device and the like. Here, the “transmission medium” represents a medium having a function to transmit information like the network such as the Internet (communication network) and a communication line (communication wire) such as the telephone line.

Furthermore, the above-described program may also be provided to implement a part of the above-described functions. Additionally, the above-described program may also be a so-called differential file (differential program) which can implement the above-described functions by being combined with a program already recorded in the computer system.

The apparatus, systems and methods in the above-described embodiments may be deployed in part or in whole through machines, a system of circuits, circuitry, hardware processors that executes computer software, software components, program codes, and/or instructions on one or more machines, a system of circuits, circuitry, hardware processors. In some cases, the one or more machines, a system of circuits, circuitry, hardware processors may be part of a general-purpose computer, a server, a cloud server, a client, network infrastructure, mobile computing platform, stationary computing platform, or other computing platform. One or more processors may be any kind of computational or processing device or devices which are capable of executing program instructions, codes, binary instructions and the like. The one or more hardware processors may be or include a signal processor, digital processor, embedded processor, microprocessor or any variants such as a co-processor, for example, math co-processor, graphic co-processor, communication co-processor and the like that may directly or indirectly facilitate execution of program codes or program instructions stored thereon. In addition, the one or more hardware processors may enable execution of multiple programs, threads, and codes. The threads may be executed simultaneously to enhance the performance of the one or more hardware processors and to facilitate simultaneous operations of the application. Program codes, program instructions and the like described herein may be implemented in one or more threads. The one or more hardware processors may include memory that stores codes, instructions and programs as described herein. The machines, a system of circuits, circuitry, hardware processors may access a non-transitory processor-readable storage medium through an interface that may store codes, instructions and programs as described herein and elsewhere. The non-transitory processor-readable storage medium associated with the machines, a system of circuits, circuitry, hardware processors for storing programs, codes, program instructions or other type of instructions capable of being executed by the computing or processing device may include but may not be limited to one or more of a memory, hard disk, flash drive, RAM, ROM, CD-ROM, DVD, cache and the like.

A processor may include one or more cores that may enhance speed and performance of a multiprocessor. In some embodiments, the process may be a dual core processor, quad core processors, other chip-level multiprocessor and the like that combine two or more independent cores.

The methods, apparatus and systems described herein may be deployed in part or in whole through a machine that executes computer software on a server, client, firewall, gateway, hub, router, or other such computer and/or networking hardware.

The software program may be associated with one or more client that may include a file client, print client, domain client, internet client, intranet client and other variants such as secondary client, host client, distributed client and the like. The client may include one or more of memories, processors, computer readable media, storage media, physical and virtual ports, communication devices, and interfaces capable of accessing other clients, servers, machines, and devices through a wired or a wireless medium, and the like. The programs or codes as described herein may be executed by the client. In addition, other devices required for execution of methods as described in this application may be considered as a part of the infrastructure associated with the client. The client may provide an interface to other devices including servers, other clients, printers, database servers, print servers, file servers, communication servers, distributed servers and the like. This coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The software program may be associated with one or more servers that may include a file server, print server, domain server, internet server, intranet server and other variants such as secondary server, host server, distributed server and the like. The server may include one or more of memories, processors, computer readable media, storage media, physical and virtual ports, communication devices, and interfaces capable of accessing other servers, clients, machines, and devices through a wired or a wireless medium, and the like. The methods, programs or codes as described herein may be executed by the server. In addition, other devices required for execution of methods as described in this application may be considered as a part of the infrastructure associated with the server. The server may provide an interface to other devices including clients, other servers, printers, database servers, print servers, file servers, communication servers, distributed servers, social networks, and the like. This coupling and/or connection may facilitate remote execution of program across the network. The networking of some or all of these devices may facilitate parallel processing of a program or method at one or more locations. Any of the devices attached to the server through an interface may include at least one storage medium capable of storing programs, codes and/or instructions. A central repository may provide program instructions to be executed on different devices. In this implementation, the remote repository may act as a storage medium for program codes, instructions, and programs.

The methods, apparatus and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing devices associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory, for example, USB sticks or keys, floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The modules, engines, components, and elements described herein, including in flow charts and block diagrams throughout the figures, imply logical boundaries between the modules, engines, components, and elements. However, according to software or hardware engineering practices, the modules, engines, components, and elements and the functions thereof may be implemented on one or more processors, computers, machines through computer executable media, which are capable of executing program instructions stored thereon as a monolithic software structure, as standalone software modules, or as modules that employ external routines, codes, services, or any combination of these, and all such implementations may be within the scope of the present disclosure. Examples of such machines may include, but is not limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, processor-embedded eyewear and the like. Furthermore, the modules, engines, components, and elements in the flow chart and block diagrams or any other logical component may be implemented on one or more machines, computers or processors capable of executing program instructions. Whereas the foregoing descriptions and drawings to which the descriptions have been referred set forth some functional aspects of the disclosed systems, no particular arrangement of software for implementing these functional aspects should be inferred from these descriptions unless explicitly stated or otherwise clear from the context. It will also be appreciated that the various steps identified and described above may be varied, and that the order of steps may be adapted to particular applications of the techniques disclosed herein. All such variations and modifications are intended to fall within the scope of this disclosure. The descriptions of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

As used herein, the following directional terms “front, back, above, downward, right, left, vertical, horizontal, below, transverse, row and column” as well as any other similar directional terms refer to those instructions of a device equipped with embodiments of the present invention. Accordingly, these terms, as utilized to describe embodiments of the present invention should be interpreted relative to a device equipped with embodiments of the present invention.

Each element for the system, device and apparatus described above can be implemented by hardware with or without software. In some cases, the system, device and apparatus may be implemented by one or more hardware processors and one or more software components wherein the one or more software components are to be executed by the one or more hardware processors to implement each element for the system, device and apparatus. In some other cases, the system, device and apparatus may be implemented by a system of circuits or circuitry configured to perform each operation of each element for the system, device and apparatus.

While the present disclosure includes many embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. An information processing system comprising:
an information acquisitor configured to acquire, from history information including at least information indicating a moving route between electric facilities uncharted on a map and utilized in past, information indicating a moving route that can be utilized at the time of moving from a first electric facility to a second electric facility based on information indicating the first electric facility out of a plurality of electric facilities and information indicating the second electric facility connected to the first electric facility by a connection line;
a screen information generator configured to generate display screen information to generate a display screen based on the information acquired by the information acquisitor and indicating the moving route; and
a display controller configured to display the display screen on a display of the information processing terminal based on the display screen information generated by the screen information generator.

2. The information processing system according to claim 1, further comprising a specifying unit configured to specify the first electric facility based on electric facility identification information to identify each of the plurality of electric facilities.

3. The information processing system according to claim 1, wherein
the information acquisitor specifies, as the first electric facility, the electric facility closest to the information processing terminal based on electric facility positional information indicating respective positions of the plurality of electric facilities and terminal positional information indicating a position of the information processing terminal.

4. The information processing system according to claim 1, wherein the information acquisitor specifies the second electric facility from among the plurality of electric facilities based on received operation.

5. The information processing system according claim 1, including history information storage configured to store the history information,
wherein the information acquisitor acquires the history information from the history information storage.

6. An information processing method comprising:
acquiring, from history information including at least information indicating a moving route between electric facilities uncharted on a map and utilized in past, information indicating a moving route that can be utilized at the time of moving from a first electric facility to a second electric facility based on information indicating the first electric facility out of a plurality of electric facilities and information indicating the second electric facility connected to the first electric facility by a connection line;
generating display screen information to generate a display screen based on the acquired information indicating the moving route; and
displaying the display screen on a display of the information processing terminal based on the generated display screen information.

7. A non-transitory computer readable storage medium that store a program that, when executed by a computer, causes the computer to perform at least:
acquire, from history information including at least information indicating a moving route between electric facilities uncharted on a map and utilized in past, information indicating a moving route that can be utilized at the time of moving from a first electric facility to a second electric facility based on information indicating the first electric facility out of a plurality of electric facilities and information indicating the second electric facility connected to the first electric facility by a connection line;
generate display screen information to generate a display screen based on the acquired information indicating the moving route; and
display the display screen on a display of the information processing terminal based on the generated display screen information.
